(19) United States
(12) Patent Application Publication
(10) Pub. No.: US 2025/0117516 A1
(43) Pub. Date: Apr. 10, 2025

(54) SYSTEMS AND METHODS FOR DYNAMICALLY DETERMINING SENSITIVE INFORMATION OF A CONTENT ELEMENT

(71) Applicant: Capital One Services, LLC, McLean, VA (US)

(72) Inventors: Matthew HUNSBERGER, Hoboken, NJ (US); Jackson WESTWOOD, New York, NY (US); Tyler MAIMAN, Melville, NY (US); Joshua EDWARDS, Philadelphia, PA (US); Ian KATZMAN, Herndon, VA (US); Shahalam BAIG, Rochester, NY (US); Shasanka BHANDARI, McLean, VA (US); Hyunwoo KANG, New York, NY (US)

(73) Assignee: Capital One Services, LLC, McLean, VA (US)

(21) Appl. No.: 18/905,164

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/62; G06F 21/10; G06F 21/60

(52) U.S. Cl. CPC G06F 21/6245; G06F 21/10; G06F 21/602

(57) ABSTRACT

Described are systems and methods for determining a content element associated with sensitive information, including receiving a content element and locative data associated with the content element, determining whether the content element includes sensitive information, upon determining the content element includes sensitive information, encrypting the content element using DRM technologies to generate a DRM-protected content element via an application server; and causing to output, via a graphical user interface (“GUI”), the DRM-protected content element based on the locative data associated with the one or more content elements determined to include sensitive information.

### CROSS-REFERENCE TO RELATED APPLICATION(S)

This application claims the benefit of pending U.S. Provisional Patent Application No. 63/587,891, filed on Oct. 4, 2023, U.S. Provisional Patent Application No. 63/665,485, filed on Jun. 28, 2024, and U.S. Provisional Patent Application No. 63/683,063, filed on Aug. 14, 2024, all of which are incorporated herein by reference in their entireties.

### TECHNICAL FIELD

Various embodiments of this disclosure relate generally to dynamically determining sensitive information and, more particularly, to systems and methods for dynamically determining sensitive information of a content element to generate digital rights management (“DRM”)-protected content elements.

### BACKGROUND

Organizations such as banks and healthcare providers seek to protect sensitive information (e.g., confidential information, personally identifiable information, financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view an account number on a bank's website, a social engineer using another computing device may persuade the user to reveal the account number to the social engineer. More specifically, the social engineer may convince the user to share the user's screen displaying the account number with the social engineer, using a screensharing or remote desktop application. In addition or in the alternative, the social engineer may convince the user to take a screenshot of the user's screen displaying the account number, using a screenshotting application, and then transmit the screenshot to the social engineer.

To guard against such social engineering, the bank may employ digital rights management (“DRM”) technologies, which are technologies that limit the use of digital content. For example, the bank may cause the user's display screen to present a video that is protected using DRM technologies. However, the DRM technologies may not be able to distinguish between information that may require DRM protection (e.g., sensitive information) and other information (e.g., non-sensitive information).

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for dynamically determining sensitive information of a content element.

In one aspect, a method for determining a content element associated with sensitive information is disclosed. The method includes receiving, via a browser module, a content element and locative data associated with the content element, determining, using a trained machine learning model, whether the content element includes sensitive information, wherein the trained machine learning model has been trained to learn associations between training data to identify an output, the training data including a plurality of: personal identifiable information, financial information, medical information, business information, government information, text data, image data, one or more images frame, audio data, one or more sequences of audio data, regular expressions (“RegEx”), or natural language prompts; upon determining the content element includes sensitive information, encrypting the content element using DRM technologies to generate a DRM-protected content element via an application server, and causing to output, via a graphical user interface (“GUI”), the DRM-protected content element based on the locative data associated with the one or more content elements determined to include sensitive information.

In another aspect, a system is disclosed. The system includes at least one memory storing instructions and at least one processor operatively connected to the memory, and configured to execute the instructions to perform operations for determining a content element associated with sensitive information. The operations may include receiving, via a browser module, a content element and locative data associated with the content element, determining, using a trained machine learning model, whether the content element includes sensitive information, wherein the trained machine learning model has been trained to learn associations between training data to identify an output, the training data including a plurality of: personal identifiable information, financial information, medical information, business information, government information, text data, image data, one or more images frame, audio data, one or more sequences of audio data, regular expressions (“RegEx”), or natural language prompts, upon determining the content element includes sensitive information, encrypting the content element using DRM technologies to generate a DRM-protected content element via an application server, and causing to output, via a graphical user interface (“GUI”), the DRM-protected content element based on the locative data associated with the content element.

In another aspect, a method for determining a content element associated with sensitive information is disclosed. The method includes receiving, via a browser module, an indication of a trigger event, upon receiving the indication of the trigger event, dynamically receiving a content element and locative data associated with the content element via the browser module, receiving, via a graphical user interface (“GUI”), at least one user input, the at least one user input including one or both of at least one natural language prompt or at least one RegEx, determining based on the content element and the at least one user input, via a trained machine learning model, one or more of: whether a first subset of the content element includes sensitive information, via a first trained sub-model of the trained machine learning model, wherein the first subset of the content element represents text data, whether a second subset of the content element includes sensitive information, via a second trained sub-model of the trained machine learning model, wherein the second subset of the content element represents image data, whether a third subset of the content element includes sensitive information, via a third trained sub-model of the trained machine learning model, wherein the third subset of the content element represents at least one image frame, or whether a fourth subset of the content element includes sensitive information, via a fourth trained sub-model of the trained machine learning model, wherein the fourth subset of the content element represents audio data, upon determining the content element includes sensitive information, tagging the content element determined to include sensitive information data to generate a tagged content element via an application server, upon generating the tagged content element, encrypting the tagged content element to generate a DRM-protected tagged content element via the application server, and causing to output based on the locative data, via the GUI, the DRM-protected tagged content element, such that the DRM-protected tagged content element is overlaid on the content element determined to include sensitive information.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for dynamically determining sensitive information, according to one or more embodiments.

FIGS. 2A-2B depict an exemplary method for dynamically determining sensitive information, according to one or more embodiments.

FIG. 3 depicts an example machine learning training flow chart, according to some embodiments of the disclosure.

FIG. 4 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “user” or the like may refer to a person authorized to access an account, attempting to access an account, etc. As used herein, the term “social engineer” may be a person or entity who seeks to manipulate a target (e.g., a customer or employee of an organization) into divulging sensitive information that may be used for fraudulent purposes. That is, a social engineer is a person or entity who engages in social engineering.

The phrase “hypertext markup language,” “HTML,” or the like may refer to a standardized system for tagging text files to achieve font, color, graphic, or hyperlink effects on World Wide Web pages. The phrase “natural language” or the like may refer to text describing the task that should performed, e.g., by a trained machine learning model. The phrase “regular expression,” “rational expression,” “RegEx,” or the like may refer to a sequence of characters that specifies a match pattern in text.

As used herein, the phrase “media content” may represent a browser, a website, a webpage, etc. As used herein, the phrase “content element” may represent text data, image data, audio data (e.g., a sequence of audio frames), or video data (e.g., a sequence of image frames). A content element may be included in HTML used to structure the website, such as a Document Object Model (“DOM”). In some aspects, the content element may include or represent sensitive or confidential information (e.g., that may be displayed on a webpage (or webpage(s), website(s), portal(s) or application(s), etc.). As used herein, the phrase “sensitive information” may include personally identifiable information (“PII”) (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), any information a user may wish to not be shared with a third party, etc.

In some embodiments, the content element may represent one or more interactive elements. An interactive element may represent data (e.g., text data, images or video) configured to perform (or trigger) an action in response to a user interacting with the interactive element (e.g., in response to a user using a cursor, a mouse, or a keyboard to select, click, double-click, right-click, click and hold, click and drag, or hover over, the interactive element, or perform a keystroke while the cursor is positioned over, or appears to contact, the interactive element). In some embodiments, the interactive element may be a button, a toggle switch, a text box, a text field, a hyperlink, or any other graphical element configured to respond to a user interaction.

As used herein, the phrase “digital extraction” may refer to any process of copying content (e.g., audio, video, text, image, etc.), such as ripping, screensharing, screenshotting, etc. As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11 or an application accessed using a Print Screen key of a keyboard or keypad).

As used herein, a “machine learning model” generally encompasses instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, or a deep neural network. Supervised or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, a bank or other organization associated with a website may use the system described herein to dynamically identify or tag content that represents sensitive or confidential information, so that the tagged content can be protected (e.g., from social engineers) when displayed on the website. Relative to existing techniques, the system described herein may allow the bank to provide more comprehensive and robust protection of the content.

While several of the examples herein involve dynamically determining sensitive information of a bank website, it should be understood that the styles and techniques according to this disclosure may be adapted to any website, platform, etc. that includes data. It should also be understood that the examples herein are illustrative only. The techniques and technologies of this disclosure may be adapted to any suitable configuration or activity.

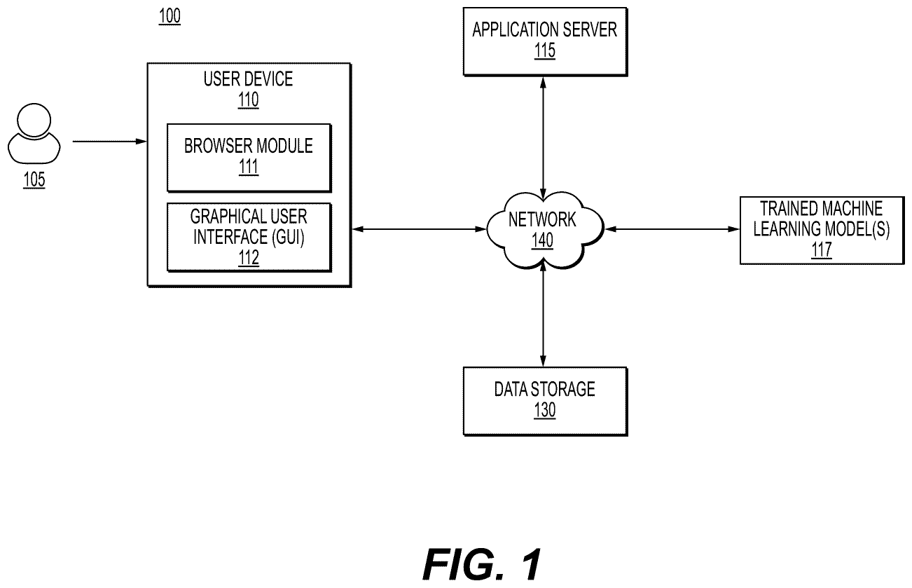

FIG. 1 depicts an exemplary environment 100 for dynamically determining sensitive information, according to one or more embodiments. In some aspects, the environment 100 may be an embodiment of (i) environment 100 described in U.S. Provisional Application 63/587,891, filed on Oct. 4, 2023, (ii) environment 100 described in U.S. Provisional Application 63/665,485, filed Jun. 28, 2024, or (iii) environment 100 described in U.S. Provisional Application 63/683,063, filed Aug. 14, 2024, where each of these U.S. provisional applications is incorporated by reference herein in its entirety.

Environment 100 may include one or more aspects that may communicate with each other over a network 140. In some embodiments, a user 105 may interact with a user device 110 such that at least one content element may be determined. In some embodiments, as described herein, the at least one content element may be associated with sensitive information. As depicted in FIG. 1, user device 110 may interact with at least one of an application server 115, a trained machine learning model(s) 117, or a data storage 130.

User device 110 may be configured to enable the user to access or interact with other systems in the environment 100. For example, user device 110 may be a computer system such as, for example, a desktop computer, a laptop computer, a tablet, a smart cellular phone, a smart watch or other electronic wearable, etc. In some embodiments, user device 110 may include one or more electronic applications, e.g., a program, plugin, browser extension, etc., installed on a memory of user device 110. In some embodiments, the electronic applications may be associated with one or more of the other components in the environment 100.

User device 110 may obtain data from one or more aspects of environment 100, such as from browser module 111, GUI 112 (e.g., via one or more inputs from user 105), application server 115, trained machine learning model(s) 117, data storage 130, etc. User device 110 may transmit data to one or more aspects of environment 100, e.g., to browser module 111, GUI 112, application server 115, trained machine learning model(s) 117, data storage 130, etc.

User device 110 may include a browser module 111 or a graphical user interface (GUI) 112. Browser module 111 may be configured to receive, determine, or transmit one or more of a content element, locative data associated with the content element, an indication of a trigger event, an indication of digital extraction (e.g., of screen sharing, screen shotting, screen capture, etc.), etc.

Browser module 111 may be configured to analyze the HyperText Markup Language (“HTML”), Document Object Model (“DOM”), Cascading Style Sheets (“CSS”), JavaScript Object Notation (“JSON”), etc. associated with a webpage to determine a content element or locative data associated with the content element. Locative data may include the location of a content element within a webpage. Locative data may be HTML data corresponding to the location, size, dimensions, etc. of the content element when the content element is caused to be output via a graphical user interface (“GUI”) (e.g., GUI 112).

In some embodiments, browser module 111 may be configured to affirmatively determine a content element. For example, browser module 111 maybe configured to scan the DOM of a webpage and determine an aspect of the HTML corresponds to a “User Information” field; the HTML corresponding to the “User Information” field may be determined to be a content element.

In some embodiments, browser module 111 may be configured to negatively determine the content element. In other words, browser module 111 may be configured to determine what data in the HTML may not be relevant. For example, browser module 111 may be configured to scan the DOM of a webpage and determine an aspect of the HTML corresponds to an advertisement space; the advertisement space may be determined (e.g., in the negative) to not correspond to a content element. In this way, browser module 111 may be configured to determine what aspects of an HTML may not be determined to be a content element.

Browser module 111 may be configured to determine an indication of a trigger event. The indication of the trigger event may include opening a plug-in, application, etc., navigating to a particular website (e.g., a pre-determined website), etc. For example, if user 105 navigates to a pre-determined website, such as a website for a financial institution, browser module 111 may be configured to determine a trigger event may be indicated.

Browser module 111 may be configured to activate an application configured to facilitate the techniques discussed herein based on the indication of the trigger event. For example, a user (e.g., user 105) may download a plug-in, application, etc. configured to facilitate the techniques discussed herein to a user device (e.g., user device 110). If the user navigates to a particular website, such as a website for a financial institution, the downloaded plug-in, application, etc. may be activated.

Browser module 111 may be configured to determine the indication of digital extraction. In some embodiments, browser module 111 may be configured to determine the indication of digital extraction by detecting indirect measures of digital extraction, e.g., via a social engineer input, a user input (e.g., a natural language prompt, a RegEx, etc.), etc. For example, browser module 111 may be configured to detect social engineer input on a device associated with the social engineer (not depicted) that may be indicative of screenshotting, such as simultaneously pressing and releasing the lock button and the volume up button on a cellular phone. In a further example, a user (e.g., user 105) may provide a natural language prompt, such as “I believe my screen is being shared.” Based on the natural language prompt, digital extraction may be indicated.

Browser module 111 may obtain data from one or more aspects of environment 100, such as from user device 110, GUI 112 (e.g., via one or more inputs from user 105), application server 115, trained machine learning model(s) 117, data storage 130, etc. Browser module 111 may transmit data to one or more aspects of environment 100, e.g., to user device 110, GUI 112, application server 115, trained machine learning model(s) 117, data storage 130, etc.

GUI 112 may be configured to receive at least one user input, such as a natural language prompt (e.g., via GUI 112), a regular expression (“RegEx”) (e.g., via GUI 112), etc. The natural language prompt may include data as text, such as “My password is XYZ.” The textual data (e.g., “My password is XYZ”) may be transmitted from GUI 112 to other aspects of environment 100, e.g., browser module 111, application server 115, trained machine learning model(s) 117, etc.

GUI 112 may obtain data via one or more inputs from user 105 or from one or more aspects of environment 100, such as from user device 110, browser module 111, application server 115, trained machine learning model(s) 117, data storage 130, etc. GUI 112 may transmit data to one or more aspects of environment 100, e.g., to user device 110, browser module 111, application server 115, trained machine learning model(s) 117, data storage 130, etc.

Application server 115 may be configured to tag the content element to generate a tagged content element. The tag may indicate that the content element includes sensitive information. In some embodiments, application server 115 may be configured to tag the content element in response to determining or receiving a determination that content element includes sensitive information. For example, application server 115 may be configured to tag the HTML associated with the content element determined to include sensitive information.

Application server 115 may be configured to encrypt the content element or the tagged content element using DRM technologies to generate a DRM-protected content element or a DRM-protected tagged content element. In some embodiments, application server 115 may be configured to encrypt the content element or the tagged content element based on determining or receiving a determination that the content element or tagged content element includes sensitive information.

Application server 115 may be configured to encrypt the content element or the tagged content element by generating DRM-protected video, text, or audio files or data associated with the content element or the tagged content element (hereinafter “DRM-protected media”). For example, application server 115 may be configured to generate DRM-protected media (e.g., a single frame-looped video) associated with the content element or the tagged content element. Encrypting the content element or tagged content element via DRM-protected media may be configured to restrict the sensitive information associated with the content element or the tagged content element from being shared or recorded (or captured) by screen sharing application(s), remote desktop application(s), or screenshotting application(s), for example. In some embodiments, application server 115 may be configured to generate an HTML element based on the DRM-protected media. For example, a first HTML element may contain the content element and the sensitive information. In encrypting the content element, application server 115 may be configured to generate a second HTML element based on the first HTML element, the sensitive information, and the encrypted DRM-protected media, such that the DRM-protected media is included in the second HTML element.

The DRM-protected media may be configured to play on a display screen (e.g., via GUI 112), and when playing, appear as a substantially transparent region or window on the display screen when the display screen is not being (i) screen-shared using a screen sharing application such as a web conferencing agent or remote computing application, or (ii) captured (or recorded) using a screenshotting application. The DRM-protected media may also be configured to stop playing, and when not playing, appear as a substantially opaque region on the display screen, when the display screen is shared using a screen sharing application or captured using a screenshotting application.

Application server 115 may be configured to determine at least one subset of the content element or tagged content element. A first subset of the content element or tagged content element may represent text data. A second subset of the content element or tagged content element may represent image data. A third subset of the content element or tagged content element may represent at least one image frame. A fourth subset of the content element or tagged content element may represent audio data.

Application server 115 may be configured to obtain data from one or more aspects of environment 100, e.g., from user device 110, browser module 111, GUI 112 (e.g., via one or more inputs from user 105), trained machine learning model(s) 117, data storage 130, etc. Application server 115 may be configured to transmit data to one or more aspects of environment 100, e.g., to user device 110, browser module 111, GUI 112, trained machine learning model(s) 117, data storage 130, etc.

Trained machine learning model(s) 117—or at least one sub-model of trained machine learning model(s) 117—may be configured to determine whether the content element, or at least one subset of the content element, includes sensitive information. In some embodiments, trained machine learning model(s) 117 may include at least one trained sub-model. For example, trained machine learning model(s) 117 may include a first trained sub-model. The first trained sub-model may be configured to determine whether the first subset of the content element (e.g., text data) includes sensitive information. In another example, trained machine learning model(s) 117 may include a second trained sub-model. The second trained sub-model may be configured to determine whether the second subset of the content element (e.g., image data) includes sensitive information. In another example, trained machine learning model(s) 117 may include a third trained sub-model. The third trained sub-model may be configured to determine whether the third subset of the content element (e.g., at least one image frame) includes sensitive information. In a further example, trained machine learning model(s) 117 may include a fourth trained sub-model. The fourth trained sub-model may be configured to determine whether the fourth subset of the content element (e.g., audio data) includes sensitive information.

In some embodiments, trained machine learning model(s) 117 may be configured to determine whether the content element or at least one subset of the content element includes sensitive information based on at least one of the indication of digital extraction, the indication of the trigger event, locative data, at least one user input (e.g., a natural language prompt, a RegEx, etc.), etc. As discussed in further detail below, trained machine learning model(s) 117 may perform one or more of: generate, store, train, or use a machine learning model configured to predict whether the content element includes sensitive information. Trained machine learning model(s) 117 may include a machine learning model or instructions associated with the machine learning model, e.g., instructions for generating a machine learning model, training the machine learning model, using the machine learning model, etc. Trained machine learning model(s) 117 may include instructions for retrieving the content element, adjusting the content element, e.g., based on the output of the machine learning model, or operating a display, e.g., GUI 112, to output the content element, e.g., as adjusted based on the machine learning model.

In some embodiments, a system or device other than trained machine learning model(s) 117 may be used to generate or train the machine learning model. For example, such a system may include instructions for generating the machine learning model, the training data and ground truth, or instructions for training the machine learning model. A resulting trained machine learning model may then be provided to trained machine learning model(s) 117.

Generally, a machine learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training or used to validate the trained machine learning model, e.g., compare the output of the trained model with the ground truth for that portion of the training data to evaluate an accuracy of the trained model. The training of the machine learning model may be configured to cause the machine learning model to learn associations between training data and ground truth data, such that the trained machine learning model may be configured to determine an output illegitimate activity alert in response to the input user marker data based on the learned associations.

Trained machine learning model(s) 117 may include training data, for example: sample data (e.g., keywords, images, sequence(s) of image frames, sequence(s) of audio frames) that commonly refer to sensitive or confidential data (e.g., credentials), personally identifiable information (“PII”) (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), text data, image data, one or more sequences of images frames, or one or more sequences of audio frames, pattern matching via regular expression, natural language prompts, etc. Trained machine learning model(s) 117 may include ground truth, for example: sample data that commonly refers to sensitive or confidential data, PII, financial information, medical information, business information, government information, text data, image data, one or more sequences of image frames, or one or more sequences of audio frames, pattern matching via regular expression (e.g., RegEx), natural language prompts, etc.

In some instances, different samples of training data or input data may not be independent. Thus, in some embodiments, the machine learning model may be configured to account for or determine relationships between multiple samples. For example, in some embodiments, the machine-learning model of marker analysis system 119 may include a Recurrent Neural Network (“RNN”). Generally, RNNs are a class of feed-forward neural networks that may be well adapted to processing a sequence of inputs. In some embodiments, the machine learning model may include a Long Short-Term Memory (“LSTM”) model or Sequence to Sequence (“Seq2Seq”) model. An LSTM model may be configured to generate an output from a sample that takes at least some previous samples or outputs into account. A Seq2Seq model may be configured to, for example, receive a sequence of user marker levels as input, and generate an illegitimate activity prediction as output.

Trained machine learning model(s) 117 may obtain data from one or more aspects of environment 100, e.g., from user device 110, browser module 111, GUI 112 (e.g., via one or more inputs from user 105), application server 115, data storage 130, etc. Trained machine learning model(s) 117 may transmit data to one or more aspects of environment 100, e.g., to user device 110, browser module 111, GUI 112, application server 115, data storage 130, etc.

Data storage 130 may be configured to receive for storage, store, retrieve from the storage, or transmit from the storage: the indication of the trigger event, the indication of digital extraction, the locative data, natural language prompts, RegEx, the content element (e.g., the content element associated with sensitive information), the tagged content element (e.g., the tagged content element associated with sensitive information), the tags, the DRM-protected media (e.g., video), the DRM-protected content element, the DRM-protected tagged content element, etc.

Data storage 130 may obtain data from one or more aspects of environment 100, e.g., from user device 110, browser module 111, GUI 112 (e.g., via one or more inputs from user 105), application server 115, trained machine learning model(s) 117, etc. Data storage 130 may transmit data to one or more aspects of environment 100, e.g., to user device 110, browser module 111, GUI 112, application server 115, trained machine learning model(s) 117, etc.

One or more of the components in FIG. 1 may communicate with each other or other systems, e.g., across network 140. In some embodiments, network 140 may connect one or more components of environment 100 via a wired connection, e.g., a USB connection between user device 110 and data storage 130. In some embodiments, network 140 may connect one or more aspects of environment 100 via an electronic network connection, for example a wide area network (WAN), a local area network (LAN), personal area network (PAN), a content delivery network (CDN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, trained machine learning model(s) 117 may be integrated in application server 115. In another example, application server 115 may be integrated in browser module 111. In some embodiments, operations or aspects of one or more of the components discussed above may be distributed amongst one or more other components. In some embodiments, some of the components of environment 100 may be associated with a common entity, while others may be associated with a disparate entity. For example, application server 115 or trained machine learning model(s) 117 may be associated with a common entity (e.g., an entity with which user 105 has an account) while data storage 130 may be associated with a third party (e.g., a provider of data storage services). Any suitable arrangement or integration of the various systems and devices of the environment 100 may be used.

Aspects of the present disclosure relate to systems and methods for identifying a content element to be protected when presented on a webpage (e.g., determining sensitive information associated with the content element when presented on a webpage). For example, a system may comprise at least one memory storing instructions, and at least one processor operatively connected to the at least one memory and configured to execute the instructions to perform operations for identifying a content element. The operations may include scanning, using an application server or a trained machine learning model, the webpage to identify a content element. In some embodiments, the operations may further include processing the content element, using a trained machine learning model, to predict whether the content element represents (e.g., includes) sensitive or confidential information. In some embodiments, the operations may include generating, using the application server, one or more videos (e.g., DRM-protected videos) associated with the content element associated with sensitive information. In some embodiments, the operations may include outputting (e.g., via browser module 111) the DRM-protected media and the content element to a display screen (e.g., via GUI 112), where each of the DRM-protected media may be displayed over (e.g., overlaid on) the content element on the display screen.

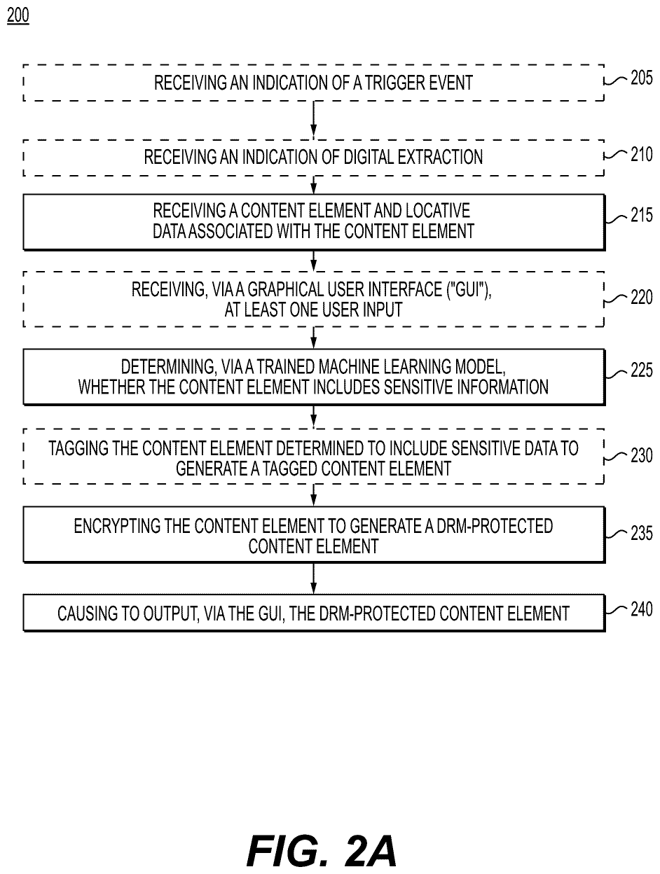

FIG. 2A depicts an exemplary method 200 for determining a content element associated with sensitive information, according to one or more embodiments. Optionally, at step 205, an indication of a trigger event may be received (e.g., via browser module 111). As discussed herein, the indication of a trigger event may be determined based on at least one of a user (e.g., user 105) opening a plug-in, application, etc., navigating to a particular website (e.g., a pre-determined website), etc. For example, if a user (e.g., user 105) navigates to a pre-determined website, such as a website for a financial institution, the trigger event may be indicated. In another example, if a user (e.g., user 105) activated (e.g., opens) a plug-in while navigating a website, the trigger event may be indicated.

At step 210, an indication of digital extraction (e.g., screen sharing, screen capturing, etc.) may be received (e.g., via application server 115). In some embodiments, digital extraction may be detected (e.g., by browser module 111) based on at least one indirect measure, such as a social engineer input, a user input (e.g., a natural language prompt, a RegEx, etc.), etc. For example, if a social engineer simultaneously presses and release the lock button and the volume up button on a device associated with the social engineer while the user (e.g., user 105) is screensharing (e.g., GUI 112 of user device 110), digital extraction may be indicated based on the social engineer input. In a further example, if a user (e.g., user 105) inputs (e.g., via GUI 112) a natural language prompt (e.g., “I believe my screen is being shared”), digital extraction may be indicated based on the natural language prompt. The natural language prompt may be analyzed (e.g., by browser module 111, application server 115, trained machine learning model(s) 117, etc.) to determine whether screen sharing, screen capturing, etc. may be detected. Analysis of a natural language prompt may be conducted as described further detail below. In some embodiments, the indication of digital extraction may be transmitted (e.g., from browser module 111 to application server 115, trained machine learning model(s) 117, etc.).

At step 215, a content element and locative data associated with the content element may be received (e.g., via browser module 111). The operations may include determining (e.g., via browser module 111) the content element based on scanning a webpage (e.g., the HTML, the DOM, the CSS, etc. of the webpage) to identify a content element and a respective location on the webpage of the content element. In some embodiments, the scanning may be dynamically performed before (e.g., prior to) the webpage is rendered on (or loaded to) a display screen of a computing device (e.g., user device 110). In some other embodiments, the scanning may be performed while the webpage is being rendered on (or loaded to) the display screen of the computing device (e.g., user device 110).

In some embodiments, the content element may be affirmatively determined (e.g., via browser module 111). For example, the DOM of a webpage may be scanned to determine an aspect of the HTML corresponds to a “User Information” field; the HTML corresponding to the “User Information” field may be determined to be a content element.

In some embodiments, the content element may be negatively determined (e.g., via browser module 111). For example, the DOM of a webpage may be scanned to determine an aspect of the HTML corresponds to an advertisement space; the advertisement space may be determined (e.g., in the negative) to not correspond to a content element. In this way, aspects of an HTML may be determined not to correspond to a content element.

In some embodiments, the operations may include determining (e.g., via application server 115) at least one subset of the content element (e.g., a first subset, a second subset, a third subset, a fourth subset, etc.). For example, the operations may include identifying a first subset of the content element, wherein the first subset of the content element represents text data. In a further example, the operations may include identifying a second subset of the content element, wherein the second subset of the content element represents image data (e.g., an image frame or a graphic). In a further example, the operations may include identifying a third subset of the content element, wherein the third subset of the content element represents one or more sequences of image frames (e.g., of a video). In a further example, the operations may include identifying a fourth subset of the content element, wherein the fourth subset of the content element represents one or more sequences of audio data. As discussed in further detail below, the at least one subset of the content element may be used as an input to a trained machine learning model (e.g., trained machine learning model(s) 117) to determine whether the content element includes sensitive information.

Optionally, at step 220, at least one user input may be received (e.g., from user 105 via GUI 112). As discussed herein, the at least one user input may include a natural language prompt (e.g., “My password is XYZ”), a RegEx, etc.

In some embodiments, the scanning discussed herein may be performed using pattern matching via RegEx. Further, in some embodiments, the trained machine learning model (e.g., trained machine learning model(s) 117) may receive the at least one user input (e.g., at least one natural language prompt) configured to direct the trained machine learning model (e.g., trained machine learning model(s) 117) to identify (or target) specific patterns of information (e.g., patterns of social security numbers) during the scanning, where the specific patterns of information may be included in the plurality of content elements. For example, the natural language prompt “scrape all SSNs” may help the machine learning model target information that matches the pattern of a U.S. Social Security number.

At step 225, it may be determined (e.g., via trained machine learning model(s) 117) whether the content element includes sensitive information. The trained machine learning model (e.g., trained machine learning model(s) 117) may represent a trained neural network model or other artificial intelligence model. In some embodiments, the operations may further include processing at least one of the content element, or at least one subset of the content element, using a trained machine learning model (e.g., via trained machine learning model(s) 117), to predict whether of the content element or the at least one subset of the content element represents (e.g., includes) sensitive or confidential information.

In some embodiments, determining whether the content element includes sensitive information may include determining at least one subset of the content element (e.g., via application server 115). As discussed herein, at least one subset may be determined based on analysis of the content element (e.g., based on analysis of the HTML, DOM, CSS, JSON, etc. associated with the content element). For example, a first subset of the content element may be determined. The first subset of the content element may represent text data. In another example, a second subset of the content element may be determined. The second subset of the content element may represent image data. In another example, a third subset of the content element may be determined. The third subset of the content element may represent at least one image frame. In a further example, a fourth subset of the content element may be determined. The fourth subset of the content element may represent audio data.

As depicted in FIG. 2B, the at least one determined subset of the content element may be analyzed (e.g., by one or more trained sub-models of the trained machine learning model) to determine whether the at least one subset includes sensitive information via method 250. In some embodiments, the trained machine learning model (e.g., trained machine learning model(s) 117) may include at least one of a first trained sub-model, a second trained sub-model, a third trained sub-model, or a fourth trained sub-model.

At step 255, the first trained sub-model may determine whether the first subset of the content element includes sensitive information. In other words, the first trained sub-model may be configured to process the first subset of the content element (e.g., text data of the content element) to predict whether the first subset of the content elements include sensitive or confidential information.

At step 260, the second trained sub-model may determine whether the second subset of the content element includes sensitive information. In other words, the second trained sub-model may be configured to process the second subset of the content element (e.g., image data of the content element) to predict whether the second subset of the content element includes sensitive or confidential information.

At step 265, the third trained sub-model may determine whether the third subset of the content element includes sensitive information. In other words, the third trained sub-model may be configured to process the third subset of the content element (e.g., image frames of the content element) to predict whether the third subset of the content element includes sensitive or confidential information.

At step 270, the fourth trained sub-model may determine whether the fourth subset of the content element includes sensitive information. In other words, the fourth trained sub-model may be configured to process the fourth subset of the content element (e.g., audio data of the content element) to predict whether the fourth subset of the content element includes sensitive or confidential information.

In some embodiments, the trained machine learning model (e.g., trained machine learning model(s) 117) may predict the presence of sensitive information in at least one of the content element or at least one subset of the content element based on at least one of the indication of digital extraction, the indication of the trigger event, locative data, at least one user input (e.g., a natural language prompt, a RegEx, etc.), etc. For example, the trained machine learning model (e.g., trained machine learning model(s) 117) may analyze a first subset of the content element based on a natural language prompt (e.g., “This text may contain sensitive information”), to determine whether the first subset of the content element includes sensitive information.

In some aspects, trained machine learning model(s) 117 (e.g., including the first sub-model, the second sub-model, the third sub-model, or the fourth sub-model of the trained machine learning model) may be trained using training data. The training data may represent sample data (e.g., keywords, images, sequence(s) of image frames, sequence(s) of audio frames) that commonly refer to sensitive or confidential data (e.g., credentials). The training data may represent PII (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), etc. Further, the training data may represent text data, image data, one or more sequences of images frames, or audio data. In some embodiments, the trained machine learning model may be trained using pattern matching via RegEx. Further, in some embodiments, the trained machine learning model may be trained to receive natural language prompts configured to direct the machine learning model being trained to identify (or target) specific patterns of information (e.g., patterns of social security numbers) during the training.

In some embodiments, trained machine learning model(s) 117 may be further trained (e.g., using browser module 111 or application server 115) to identify sensitive or confidential information. For example, trained machine learning model(s) 117 may be further trained using data (e.g., text data, image data, sequence(s) of image frames, audio data, pre-captured data or pre-recorded data) retrieved from a user (e.g., user 105) of the computing device (e.g., user device 110). Where the trained machine learning model(s) 117 outputs a false positive (e.g., an incorrect indication or prediction that a respective content element represents sensitive or confidential information) or a false negative (e.g., an incorrect indication or prediction that a respective content element does not represent sensitive or confidential information), user 105 may provide feedback to the trained machine learning model regarding the erroneous outputs or predictions (e.g., via GUI 112). Further, trained machine learning model(s) 117 may be configured to improve the accuracy of subsequent outputs or predictions based on the feedback. In some aspects, trained machine learning model(s) 117 may be trained to operate in computing environments associated with the user (e.g., user 105).

Returning to FIG. 2A, optionally at step 230, the content element determined to include sensitive information may be tagged (e.g., via application server 115), thereby generating a tagged content element. In some embodiments, the tag may indicate (e.g., represent) that the content element includes sensitive information. In some aspects, the operations may include tagging (e.g., using trained machine learning model(s) 117 or application server 115) the HTML, DOM, CSS, JSON, etc. of the content element determined to include sensitive information. That is, the HTML, DOM, CSS, JSON, etc. of the content element determined to include sensitive information may be tagged (e.g., flagged or marked) to indicate that the respective content element represents sensitive or confidential information and should be protected (e.g., from social engineering or unauthorized disclosure). In some embodiments, an aspect of the content element that may include the sensitive information may be tagged. For example, if the content element is determined to include sensitive information based on analysis of the first subset of the content element (e.g., text data), the relevant (e.g., sensitive) text data may be tagged.

In some embodiments, the user of the computing device (e.g., user 105 via user device 110)) may tag the content element or un-tag the tagged content element. For example, a content element may not be tagged as including sensitive information (e.g., by trained machine learning model(s) 117), but user 105 may want the content element to be tagged. In some embodiments, user 105 may provide an input (e.g., via GUI 112), such as a natural language prompt (e.g., “tag any SSN as sensitive”), for a given content element to be tagged. The natural language prompt may be processed as discussed herein, and may result in the content element being tagged. In a further example, a content element may be tagged as including sensitive information (e.g., by trained machine learning model(s) 117), but user 105 may not want the content element to be tagged. The user (e.g., user 105) may provide an input (e.g., via GUI 112), such as a natural language prompt (e.g., “do not tag any email addresses as sensitive”), for a given content element to be tagged. The natural language prompt may be processed as discussed herein, and may result in the content element being untagged.

At step 235, the content element may be encrypted to generate a DRM-protected content element. In some embodiments, encrypting the content element may include generating (e.g., using application server 115) at least one video (e.g., a visual representation of the sensitive information) associated with the content element determined to include sensitive information or the tagged content element. In some embodiments, a video may be generated for each respective content element of a plurality of content elements determined to include sensitive information. For example, if three content elements are determined to include sensitive information, three videos, each associated with a respective content elements determined to include sensitive information, may be generated. In some embodiments, a video may be generated for multiple content elements of the plurality of content elements determined to include sensitive information. For example, if three content elements are determined to include sensitive information, a single video (e.g., a single frame-looped video) may be generated and associated (e.g., collectively associated) with the three content elements determined to include sensitive information.

Further, in some embodiments, the at least one video may be generated in response to receipt of the indication of the trigger event (e.g., via browser module 111). For example, receiving a request to load (or display) the webpage on the display screen of the computing device (e.g., GUI 112 of user device 110) may initiate generation of the at least one video. In a further example, initiation of a browser plug-in (e.g., in response to navigating to a pre-determined webpage) may initiate generation of the at least one video.

In some embodiments, encrypting the content element may include encrypting the at least one video (e.g., a single frame-looped video) using DRM technologies to generate DRM-protected media. In some aspects, the DRM-protected media generated may protect, redact, obfuscate, or censure the content element. In some aspects, the DRM technologies may restrict the at least one video from being shared or recorded (or captured) using at least one screen sharing application, remote desktop application, screenshotting application, etc. The operations may include transmitting (e.g., via application server 115) the DRM-protected media to a display screen (e.g., to GUI 112) to cause to be output.

Further, the operations may include forming (e.g., via browser module 111, application server 115, etc.) at least one HTML element that include the DRM-protected media. For example, a first HTML element may contain the content element and the sensitive information. In encrypting the content element, a second HTML element may be generated (e.g., via application server 115) based on the first HTML element, the sensitive information, or the encrypted DRM-protected media, such that the second HTML element includes the DRM-protected media and the relevant data of the first HTML element (e.g., locative data, formatting data, etc.).

At step 240, at least one of the DRM-protected content element (and associated DRM-protected media), the DRM-protected tagged content element (and associated DRM-protected media), or the at least one HTML elements may be caused to be output (e.g., via GUI 112). For example, where the DRM-protected content element is included in a second HTML element, the operations may include outputting (e.g., via GUI 112) the second HTML element such that the DRM-protected media of the DRM-protected content element is displayed via a display screen (e.g., GUI 112).

In some aspects, the DRM-protected content element (and associated DRM-protected media), the DRM-protected tagged content element (and associated DRM-protected media), or the at least one HTML elements may be caused to be output (e.g., via GUI 112) based on the locative data (received at step 205). For example, the DRM-protected media may be displayed over (e.g., overlaid on) the content element on the display screen (e.g., GUI 112) based on the locative data.

In some embodiments, as discussed herein (e.g., see step 210), it may be determined (e.g., via browser module 111) whether the display screen is being screen shared or screenshotted (e.g., whether digital extraction is indicated). In some aspects, the electronic sharing may or may not be recorded. As a result, the DRM-protected media may protect the content element and associated sensitive information from being shared with or captured for a social engineer by converting to a form that substantially blocks the content element from view via a display screen associated with the social engineer, as discussed in more detail below.

In some embodiments, where it is not detected (e.g., by browser module 111) that the display screen (e.g., GUI 112) is being electronically shared or recorded (or captured), the DRM-protected media may be played and appear as a transparent region on the display screen (e.g., GUI 112) during the playing so that a person who views the display screen (e.g., GUI 112) can view the one or more content elements presented under the DRM-protected media. For example, where the display screen (e.g., GUI 112) is not being electronically shared or recorded (or captured), the DRM-protected media may be output such that the DRM-protected media may be played and appear as a transparent region on the display screen (e.g., GUI 112) during the playing so that a person who views the display screen (e.g., GUI 112) can view the content element and associated sensitive information presented under the overlaid DRM-protected media.

In some embodiments, where it is not detected (e.g., by browser module 111) that the display screen (e.g., GUI 112) is being electronically shared or recorded (or captured), the DRM-protected media may not be displayed. For example, where the DRM-protected media includes a video that is a visual representation of the sensitive information, the video may be caused to not be displayed (e.g., via GUI 112) where it is not detected that the display screen is being electronically shared or recorded (or captured).

Conversely, in some embodiments, where it is detected (e.g., by browser module 111) that the display screen (e.g., GUI 112) is being electronically shared or recorded (or captured) (e.g., that digital extraction is indicated), the DRM-protected media may be caused to stop playing (or not play) (e.g., by browser module 111, application server 115, etc.). While the one or more videos are not playing, the DRM-protected media may appear as an opaque region (e.g., a censor bar) that conceals the content element and associated sensitive information presented under the DRM-protected media. For example, where the display screen (e.g., GUI 112) is being electronically shared or recorded, the DRM technologies (or protections) of the DRM-protected media may cause the DRM-protected media to stop playing, not play, become substantially opaque, etc. As such, for example, while the DRM-protected media is not playing, the DRM-protected media may appear as an opaque region that conceals the content element and associated sensitive information present under the DRM-protected media. As a result, the DRM-protected media may protect the content element from being shared with or captured by a social engineer.

It should be noted that the techniques described herein may be applied to a plurality of content elements. For example, if five content elements are determined in a webpage, the five content elements may be analyzed using the techniques described herein to determine if any of the five content elements include sensitive information. If two of the content elements are determined to include sensitive information, the two content elements may be encrypted using DRM technologies, and the two DRM-encrypted content elements may be caused to be output via a display screen (e.g., via GUI 112).

It should be noted that the steps of methods 200, 250 may occur before a content is displayed. In other words, before a webpage is loaded for a user (e.g., user 105) to view (e.g., via GUI 112), any of steps 205-270 may dynamically occur. For example, the trigger event may be indicated (step 205) based on a user navigating to a webpage. Before the webpage is caused to be displayed (e.g., via GUI 112), a content element and associated locative data may be determined (step 215), and the content element may be analyzed to determine whether the content element includes sensitive information (steps 225, 255-270). Upon determining the content element includes sensitive information, the content element may be tagged (step 230) or encrypted (step 235), and caused to be output (e.g., via GUI 112) before the webpage is caused to be displayed. In this way, display of unencrypted sensitive information (e.g., via GUI 112) may be prevented entirely.

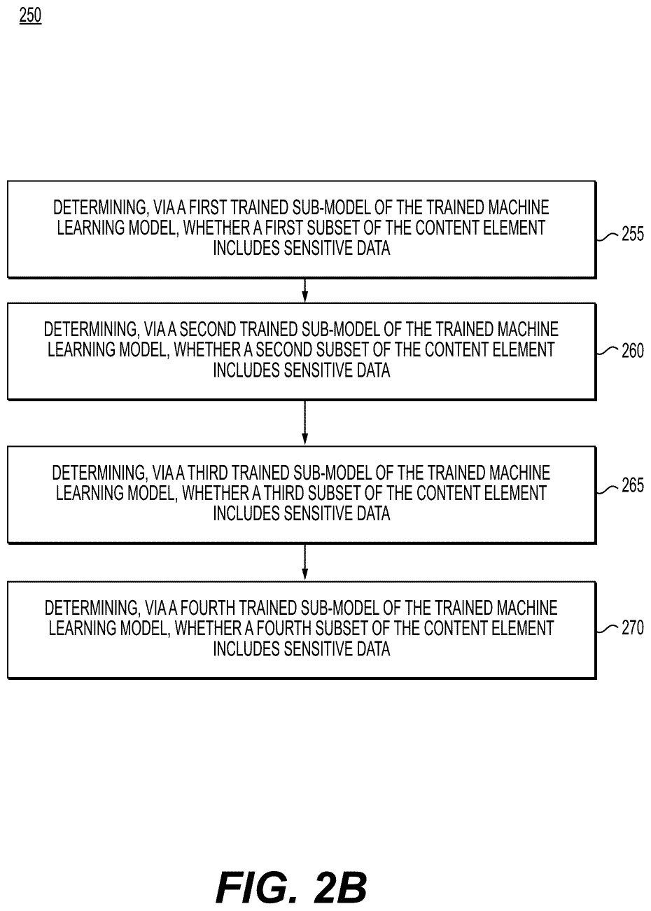

One or more implementations disclosed herein include or are implemented using a machine learning model (e.g., trained machine learning model(s) 117) are implemented using a machine learning model or are used to train the machine learning model. A given machine learning model may be trained using the training flow chart 300 of FIG. 3. The training data 312 may include one or more of stage inputs 314 and the known outcomes 318 related to the machine learning model to be trained. The stage inputs 314 are from any applicable source including text, visual representations, data, values, comparisons, and stage outputs, e.g., one or more outputs from one or more steps from FIGS. 2A-2B. The known outcomes 318 are included for the machine learning models generated based on supervised or semi-supervised training. An unsupervised machine learning model is not trained using the known outcomes 318. The known outcomes 318 includes known or desired outputs for future inputs similar to or in the same category as the stage inputs 314 that do not have corresponding known outputs.

The training data 312 and a training algorithm 320, e.g., one or more of the modules implemented using the machine learning model or are used to train the machine learning model, is provided to a training component 330 that applies the training data 312 to the training algorithm 320 to generate the machine learning model. According to an implementation, the training component 330 is provided comparison results 316 that compare a previous output of the corresponding machine learning model to apply the previous result to re-train the machine learning model. The comparison results 316 are used by the training component 330 to update the corresponding machine learning model. The training algorithm 320 utilizes machine learning networks or models including, but not limited to a deep learning network such as a transformer, Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, or discriminative models such as Decision Forests and maximum margin methods, the model specifically discussed herein, or the like.

The machine learning model used herein is trained or used by adjusting one or more weights or one or more layers of the machine learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights or layers.

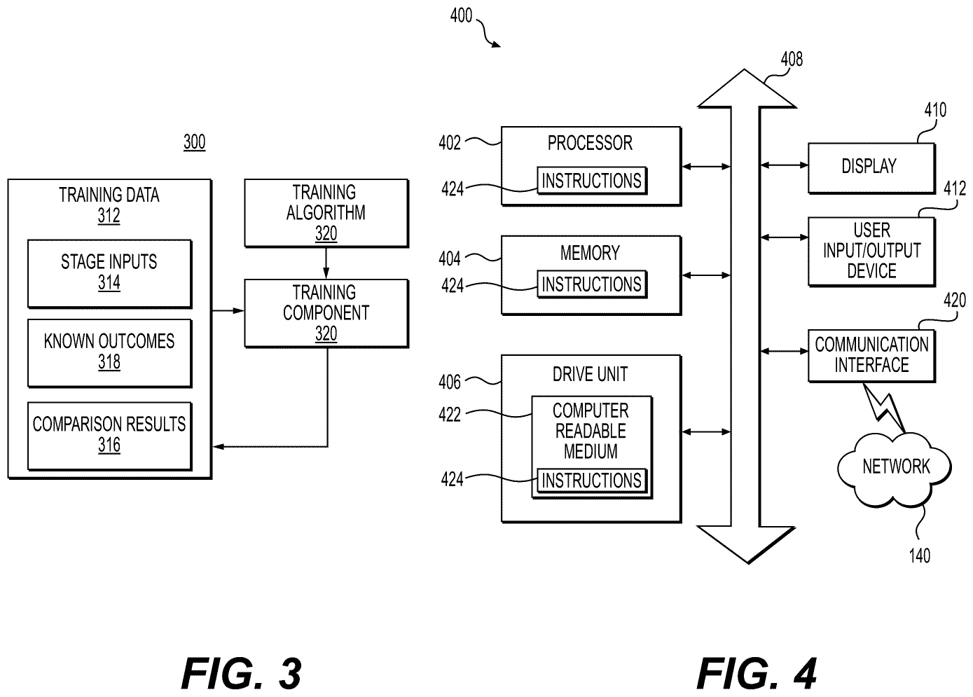

FIG. 4 depicts a simplified functional block diagram of a computer 400 that may be configured as a device for executing the methods disclosed here, according to exemplary embodiments of the present disclosure. For example, the computer 400 may be configured as a system according to exemplary embodiments of this disclosure. In various embodiments, any of the systems herein may be a computer 400 including, for example, a data communication interface 420 for packet data communication. The computer 400 also may include a central processing unit (CPU) 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 or computer readable medium 422). The computer 400 also may include input and output ports 412 or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention. The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for determining a content element associated with sensitive information, the method comprising:
receiving, via a browser module, a content element and locative data associated with the content element;
determining, using a trained machine learning model, whether the content element includes sensitive information,
wherein the trained machine learning model has been trained to learn associations between training data to identify an output, the training data including a plurality of: personal identifiable information, financial information, medical information, business information, government information, text data, image data, one or more images frame, audio data, one or more sequences of audio data, regular expressions (“RegEx”), or natural language prompts;
upon determining the content element includes sensitive information, encrypting the content element using DRM technologies to generate a DRM-protected content element via an application server; and
causing to output, via a graphical user interface (“GUI”), the DRM-protected content element based on the locative data associated with the one or more content elements determined to include sensitive information.

2. The method of claim 1, further comprising:
receiving, via the browser module, an indication of a trigger event; and
upon obtaining the indication of the trigger event, receiving the content element and the locative data associated with the content element via the browser module.

3. The method of claim 1, further comprising dynamically retrieving the content element while media data is being rendered via the GUI.

4. The method of claim 1, further comprising dynamically retrieving the content element prior to media data being rendered via the GUI.

5. The method of claim 1, wherein the content element is included in Hypertext Markup Language (“HTML”) element of a document object model (“DOM”).

6. The method of claim 5, further comprising:
scanning, via the trained machine learning model, the DOM associated with a webpage to determine the content element and the locative data associated with the content element.

7. The method of claim 1, further comprising:
determining, via the application server, one or more of:
a first subset of the content element, wherein the first subset of the content element represents text data,
a second subset of the content element, wherein the second subset of the content element represents image data,
a third subset of the content element, wherein the third subset of the content element represents at least one image frame, or
a fourth subset of the content element, wherein the fourth subset of the content element represents audio data.

8. The method of claim 7, wherein the determining, using the trained machine learning model, whether the content element includes the sensitive information further comprises:
determining, via a first trained sub-model of the trained machine learning model, whether the first subset of the content element includes sensitive information;
determining, via a second trained sub-model of the trained machine learning model, whether the second subset of the content element includes sensitive information;
determining, via a third trained sub-model of the trained machine learning model, whether the third subset of the content element includes sensitive information; and
determining, via a fourth trained sub-model of the trained machine learning model, whether the fourth subset of the content element includes sensitive information.

9. The method of claim 1, further comprising:
receiving, via the GUI, at least one user input, the at least one user input including one or both of at least one natural language prompt or at least one RegEx; and
determining, via the trained machine learning model, whether the content element includes sensitive information based on one or both of the at least one natural language prompt or the at least one RegEx.

10. The method of claim 1, further comprising:
upon determining the content element includes sensitive information, tagging the content element determined to include sensitive information to generate a tagged content element;
upon generating the tagged content element, encrypting the tagged content element to generate a DRM-protected tagged content element via the application server; and
causing to output, via the GUI, the DRM-protected tagged content element.

11. A system, the system comprising:
at least one memory storing instructions; and
at least one processor operatively connected to the memory, and configured to execute the instructions to perform operations for determining a content element associated with sensitive information, the operations including:
receiving, via a browser module, a content element and locative data associated with the content element;
determining, using a trained machine learning model, whether the content element includes sensitive information,
wherein the trained machine learning model has been trained to learn associations between training data to identify an output, the training data including a plurality of: personal identifiable information, financial information, medical information, business information, government information, text data, image data, one or more images frame, audio data, one or more sequences of audio data, regular expressions (“RegEx”), or natural language prompts;
upon determining the content element includes sensitive information, encrypting the content element using DRM technologies to generate a DRM-protected content element via an application server; and
causing to output, via a graphical user interface (“GUI”), the DRM-protected content element based on the locative data associated with the content element.

12. The system of claim 11, wherein the operations further include dynamically retrieving the content element while media data is being rendered via the GUI.

13. The system of claim 11, wherein the operations further include dynamically retrieving the content element prior to media data being rendered via the GUI.

14. The system of claim 11, wherein the content element is included in Hypertext Markup Language (“HTML”) element of a document object model (“DOM”).

15. The system of claim 14, wherein the operations further include:
scanning, via the trained machine learning model, the DOM associated with a webpage to determine the content element and the locative data associated with the content element.

16. The system of claim 11, wherein the operations further include:
determining, via an application server, one or more of:
a first subset of the content element, wherein the first subset of the content element represents text data,
a second subset of the content element, wherein the second subset of the content element represents image data,
a third subset of the element, wherein the third subset of the content element represents at least one image frame, or
a fourth subset of the content element, wherein the fourth subset of the content element represents audio data.

17. The system of claim 16 wherein the determining, using the trained machine learning model, whether the content element includes the sensitive information further comprises:
determining, via a first trained sub-model of the trained machine learning model, whether the first subset of the content element includes sensitive information;
determining, via a second trained sub-model of the trained machine learning model, whether the second subset of the content element includes sensitive information;
determining, via a third trained sub-model of the trained machine learning model, whether the third subset of the content element includes sensitive information; and
determining, via a fourth trained sub-model of the trained machine learning model, whether the fourth subset of the content element includes sensitive information.

18. The system of claim 11, further comprising:
receiving, via the GUI, at least user input, the at least one user input including one or both of at least one natural language prompt or at least one RegEx; and
determining, via the trained machine learning model, whether the content element includes sensitive information based on one or both of the at least one natural language prompt or the at least one RegEx.

19. The system of claim 11, further comprising:
upon determining the content element includes sensitive information, tagging the content element determined to include sensitive information to generate a tagged content element;
upon generating the tagged content element, encrypting the tagged content element to generate a DRM-protected tagged content element via the application server; and
causing to output, via the GUI, the DRM-protected tagged content element.

20. A method for determining a content element, the method comprising:
receiving, via a browser module, an indication of a trigger event;
upon receiving the indication of the trigger event, dynamically receiving a content element and locative data associated with the content element via the browser module;
receiving, via a graphical user interface (“GUI”), at least one user input, the at least one user input including one or both of at least one natural language prompt or at least one RegEx;
determining based on the content element and the at least one user input, via a trained machine learning model, one or more of:
whether a first subset of the content element includes sensitive information, via a first trained sub-model of the trained machine learning model, wherein the first subset of the content element represents text data;
whether a second subset of the content element includes sensitive information, via a second trained sub-model of the trained machine learning model, wherein the second subset of the content element represents image data;
whether a third subset of the content element includes sensitive information, via a third trained sub-model of the trained machine learning model, wherein the third subset of the content element represents at least one image frame; or
whether a fourth subset of the content element includes sensitive information, via a fourth trained sub-model of the trained machine learning model, wherein the fourth subset of the content element represents audio data;
upon determining the content element includes sensitive information, tagging the content element determined to include sensitive information data to generate a tagged content element via an application server;
upon generating the tagged content element, encrypting the tagged content element to generate a DRM-protected tagged content element via the application server; and
causing to output based on the locative data, via the GUI, the DRM-protected tagged content element, such that the DRM-protected tagged content element is overlaid on the content element determined to include sensitive information.
